(19) United States
(12) Patent Application Publication
(10) Pub. No.: US 2011/0145924 A1
(43) Pub. Date: Jun. 16, 2011

(54) METHOD FOR DETECTION AND PREVENTION OF LOADING EXECUTABLE FILES FROM THE CURRENT WORKING DIRECTORY

(76) Inventors: Mitja Kolsek, Maribor (SI); Stanka Salamun, Maribor (SI); Jure Skofic, Maribor (SI)

(21) Appl. No.: 12/960,507

(22) Filed: Dec. 5, 2010

(30) Foreign Application Priority Data
Dec. 11, 2009 (SI) P-200900380

(51) Int. Cl. G06F 21/00

(52) U.S. Cl. 726/25

(57) ABSTRACT

The present invention detects vulnerabilities by observing (“monitoring”) the calls of system and application functions, and the arguments of such calls, which play a key role in loading executable files, and detects that a computer program or operating system either has tried, is trying or will try to load or execute an executable file from the current working directory. The present invention extends the detection procedure with an active intervention into the execution of a computer program or operating system such that loading or execution of the executable file is prevented. The present invention limits exploitability of the described vulnerability, by limiting loading or execution of executable files from the current working directory, or limiting or preventing setting of the current working directory to locations where a malicious person could place an executable file.

### FIELD OF THE INVENTION

This invention is in the field of application systems for automated detection and mitigation of vulnerabilities in software products, using observation and modification of behavior of a software product, primarily using instrumentation, such as disclosed, for example, in http://en.wikipedia.org/wiki/Instrumentation_(computer_programming), incorporated herein by reference, replacement or modification of operating system executable files, and detection of events that indicate the presence of vulnerability.

### BACKGROUND OF THE INVENTION

The technical problem solved by this invention is implementing an automated procedure for detecting vulnerabilities in software products, which potentially enable planting of malicious binaries and their subsequent loading from the current working directory, and preventing exploitation of such vulnerabilities.

Modern software contains many different vulnerabilities, which enable malicious persons to perform various unwanted activities such as data theft, altering or deleting of data, disabling services or installing malicious code on computers and computer equipment belonging to users and organizations.

The present invention addresses a specific type of attack known as “Planting executable files in the current working directory” or “Binary planting”, where the attacker causes the execution of a malicious shared library (i.e., a DLL file) or executable (i.e., an EXE file) from the current working directory on a user's computer. A binary planting attack involves two steps: (a) planting of one or more malicious executable files somewhere on a file system and (b) execution of these files by one or more processes running on the user's machine.

This type of attack is possible due to the vulnerable procedures of loading executable files, implemented by the Microsoft Windows operating systems (including Windows 2000, Windows NT, Windows 2003, Windows XP, Windows Vista and Windows 7) and associated programming libraries.

The procedures of loading executable files differ slightly between versions of Windows operating systems and also depend on the installed patches/updates and the operating system configuration. In addition, these procedures are different for loading programming libraries and computer programs. It is common to all these procedures, though, that when the executable file is specified with a so-called “relative” path (i.e., is not specified with a “full” or “absolute” path on the file system), they search for this file based on the file name in specified locations in a specified order (these locations are documented on Microsoft's public web sites). When the executable file with the specified name is found, the system or process loads it and possibly executes parts of its code.

The locations where the system or process is searching for the requested executable file are generally as follows:
1. “home directory”, the directory hosting the main executable file of the process that triggered the loading of the executable file;
2. system directories (e.g., C:\Windows, C:\Windows\System32 in C:\Windows\System);
3. current working directory; and
4. some other directories, which may be irrelevant to the present invention.

The search order in any particular case may be different from the above, and does not necessarily include all abovementioned locations.

In a general case, default access permissions on the system prevent a malicious person from creating a malicious executable file either in the home directory or the system directories—which is an important security measure. The vulnerability of the procedures for loading executable files thus lies in the fact that the list of locations to be searched for includes the current working directory. Depending on the location the current working directory is pointing to at the time of loading an executable file, it may be possible to place (“plant”) a malicious executable on this location and get the system or process to load and execute it instead of the legitimate executable file it was looking for. The system or process loading an executable file will only load such “planted” file from the current working directory if it doesn't find the legitimate one in the “priority” locations, i.e., the locations in the search order that precede the current working directory.

There exist many methods for setting the current working directory of a process to some location where a malicious person can create a malicious file. The most obvious method is provided by a system application called Windows Explorer (the primary tool for managing files and user desktop on Windows systems), which sets the current working directory to the location of any data file the user double-clicks on. For instance, when a user double-clicks on a Microsoft Word document icon, Windows Explorer launches the Microsoft Word application, sets the current working directory of this application to the location of the Microsoft Word document and opens this file in the newly-launched application. If the application later tries to load or execute an executable file and this file is neither found in the application's home directory nor in the system directories, it will try to load it from the current working directory. As the current working directory can be—for instance due to the aforementioned behavior of Windows Explorer—set to a location under a malicious person's control (e.g., a network shared folder), a malicious executable file can be loaded and executed on user's computer.

The described vulnerability is present in a large number of widely-used applications, but there is currently no widely-known efficient procedure for its detection.

There are numerous commercial and free tools available for detecting some types of vulnerabilities in web services and web applications, which send various requests to web servers and detect the presence of vulnerabilities based on the servers' responses.

Today, automated vulnerability detection in general-purpose software products is performed mostly using automated source code or compiled code analysis. Only a handful of tools use run-time observation of computer processes for this purpose.

One of the most advanced such tools is the Microsoft Application Verifier, which is disclosed at http://www.microsoft.com/downloads/details.aspx?FamilyID=C4A25AB9-649D-4A1B-B4A7-C9D8B095DF18&displaylang=en, incorporated herein by reference. Microsoft Application Verifier observes computer processes running on Windows systems and detects some types of vulnerabilities, for instance the creation of system objects with inappropriate access control or the use of uninitialized variables. This tool does not detect vulnerabilities addressed by this invention.

The Microsoft Windows system provides a function called SetDllDirectory, which a developer can use to modify the procedure for loading programming libraries. This function replaces the current working directory in the search order with a specific directory. This function, however, does not modify the procedure for executing computer programs.

Microsoft's publicly accessible documentation does not describe any way for preventing the loading of executable files from the current working directory on a systemic level (for all processes). It is possible to modify the behavior of the SearchPath function on a systemic level via registry settings and prevent this function from looking for the executable file in the current working directory first, but even Microsoft, for security reasons, discourages developers from using this function for locating programming libraries.

The current state of art is also evident from the following sources, all of which are incorporated herein by reference:
[1] Wikipedia, >>Instrumentation (computer programming)<< http://en.wikipedia.org/wiki/Instrumentation_(computer_programming)
[2] Microsoft, >>Dynamic-Link Library Search Order<< http://msdn.microsoft.com/en-us/library/ms682586(VS.85).aspx
[3] Microsoft, >>CreateProcess Function<< http://msdn.microsoft.com/en-us/library/ms682425(VS.85).aspx
[4] Microsoft, >>ShellExecute Function<< http://msdn.microsoft.com/en-us/library/bb762153(VS.85).aspx
[5] Microsoft, >>WinExec Function<< http://msdn.microsoft.com/en-us/library/ms687393(VS.85).aspx
[6] Microsoft, >>Microsoft Application Verifier<< http://www.microsoft.com/downloads/details.aspx?FamilyID=C4A25AB9-649D-4A1B-B4A7-C9D8B095DF18&displaylang=en
[7] Microsoft, >>Testing Applications with AppVerifier<< http://msdn.microsoft.com/library/default.asp?url=/library/en-us/dnappcom/html/AppVerifier.asp
[8] Microsoft, >>CreateProcessAsUser Function<< http://msdn.microsoft.com/en-us/library/ms682429(VS.85).aspx
[9] Microsoft, >>CreateProcessWithLogonW Function<< http://msdn.microsoft.com/en-us/library/ms682431(VS.85).aspx
[10] Microsoft, >>CreateProcessWithTokenW Function<< http://msdn.microsoft.com/en-us/library/ms682434(VS.85).aspx
[11] Microsoft, >>LoadLibrary Function<< http://msdn.microsoft.com/en-us/library/ms684175(VS.85).aspx
[12] Microsoft, >>LoadLibraryEx Function<< http://msdn.microsoft.com/en-us/library/ms684179(VS.85).aspx
[13] Microsoft, >>ShellExecuteEx Function<< http://msdn.microsoft.com/en-us/library/bb762154(VS.85).aspx
[14] Ivo Ivanov, >>API Hooking Revealed<< http://www.codeguru.com/Cpp/W-P/system/misc/article.php/c5667
[15] Microsoft, >>NtQueryAttributesFile Function<< http://msdn.microsoft.com/en-us/library/cc512135(VS.85).aspx
[16] Microsoft, >>SearchPath Function<< http://msdn.microsoft.com/en-us/library/aa365527(VS.85).aspx

### SUMMARY OF THE INVENTION

The abovementioned technical problem is solved by a method for detection and prevention of loading executable files from the current working directory. The procedure runs on a general-purpose processor and represents a technical solution to a technical problem, as a general-purpose processor with its instruction set and execution of its steps is changed by this invention into a new configuration, which solves the abovementioned technical problem.

The core of the described method of the present invention in terms of detecting vulnerabilities is in observing (“monitoring”) the calls of system and application functions, and the arguments of such calls, which play a key role in loading executable files, and detecting that a computer program or operating system either has tried, is trying or will try to load or execute an executable file from the current working directory.

The core of the described method in terms of preventing the exploitation of vulnerabilities is in extending the detection procedure with an active intervention into the execution of a computer program or operating system such that loading or execution of the executable file is prevented.

Additionally the present invention provides methods for limiting exploitability of the described vulnerability, which either limit loading or execution of executable files from the current working directory, or limit or prevent setting of the current working directory to locations where a malicious person could place an executable file. Typical examples of such locations are: network paths or network shared folders; removable storage, e.g., CD-ROM or USB drives; or local directories on a computer's file system where access rights allow a low-privileged user or a remote user to create an executable file.

The term “file system location where a malicious person could create an executable file” as used in the present application, is defined as a file system location or multiple such locations, which can either be specified explicitly, with patterns, in one or multiple lists, with external sources, with programming logic or with any combination thereof. The term “file system location where a malicious person can't create an executable file” as used in the present application is defined as all other file system locations.

### BRIEF DESCRIPTION OF THE DRAWINGS

FIG. 1 is a block diagram illustrating a system call hooking to monitor calls to function LdrLoadDll.

FIG. 2 is a block diagram illustrating a system call hooking to monitor calls to function NtQueryAttributesFile.

FIG. 3 is a block diagram illustrating a case of function CreateProcessA.

FIG. 4 is a block diagram illustrating system call hooking to monitor calls to function NtQueryAttributesFile.

### DETAILED DESCRIPTION OF THE INVENTION

Detection or monitoring of function calls (including their arguments) and modification of functions' behavior can be done with any of the known methods or combinations thereof, for example: instrumentation (Wikipedia, >>Instrumentation (computer programming)<< http://en.wikipedia.org/wiki/Instrumentation_(computer_programming)), library replacement or DLL replacement, executable replacement or “binary replacement”, DLL redirection, Import address table patching, function patching or code overwriting, modification of calls or function code in source code or compiled code of libraries, proxy DLLs, API hooking [14] (Ivo Ivanov, API Hooking Revealed http://www.codeguru.com/Cpp/W-P/system/misc/article.php/c5667) or system call hooking.

An experienced Windows software development expert can use publicly accessible documents, code examples and libraries to relatively easily implement such monitoring or modification of any exported function's behavior in any executable file.

Detection of binary planting vulnerabilities is implemented by monitoring calls to the following functions, whether in user space or in kernel space:
LoadLibraryA and LoadLibraryW
LoadLibraryExA and LoadLibraryExW
LdrLoadDll
NtQueryAttributesFile
RtlAppendUnicodeStringToString
NtCreateSection and ZwCreateSection
NtCreateProcess and ZwCreateProcess
CreateProcessA and CreateProcessW
CreateProcessAsUserA and CreateProcessAsUserW
CreateProcessWithLogonW
CreateProcessWithTokenW
CreateProcessInternalA and CreateProcessInternalW
WinExec
ShellExecuteA and ShellExecuteW
ShellExecuteEx, ShellExecuteExA and ShellExecuteExW or
other functions that are functionally equivalent to those listed above or play a similar role in the process of loading or executing executable files.

The term “relative path”, in contrast to the “absolute path” or “full path”, as used in the present application, is defined as a path to a file, which is not uniquely specified and is therefore relative to some base path or a multiple of base paths, to which this relative path is appended to form an absolute path in the process of locating a file. For instance, >>test\test.exe<< and >>test.exe<< are both relative paths, while >>c:\test\test.exe<< is an absolute or full path.

The following describes detection and prevention of loading programming libraries from the current working directory, first in general and then with a description of specific implementation cases.

Detection and prevention of loading programming libraries from the current working directory is implemented with any combination of the following embodiments.

In a first embodiment, (Procedure 1), the system is programmed to detect calls to any one or both functions LoadLibraryA, LoadLibraryW. If the path to the programming library (argument lpFileName) is relative, the system checks for the existence of files on the file system upon function entry and determines in advance whether the procedure for finding the library will find it in some location in the search path before trying to find it in the current working directory. If a file with such name is not found in these “priority locations” in the search path, the system concludes that an attempt to load the programming library from the current working directory will take place.

In a variation of the first embodiment (Procedure 1A), after the system determines that an attempt to load the programming library from the current working directory will take place, the system prevents it by conditionally or unconditionally doing one or more of the following:
modifying the input arguments of the called function such that loading of the programming library from the current working directory will not succeed or the library's code will not execute (e.g., by changing the path to the programming library);
setting the current working directory to a location where a malicious person can't create an executable file; or
terminating the execution of the called function and thereby the procedure of loading the programming library.

In a second embodiment (Procedure 2) the system is programmed to detect calls to any one or both functions LoadLibraryExA, LoadLibraryExW. If the path to the programming library (argument lpFileName) is relative, the system is programmed to check for the existence of files on the file system upon function entry and determine in advance whether the procedure for finding the library will find it in some location in the search path before trying to find it in the current working directory. If a file with such name is not found in these “priority locations” in the search path, the system concludes that an attempt to load the programming library from the current working directory will take place.

A variation of the second embodiment (Procedure 2.1) is the same as procedure 2, but in addition checks whether the flags (argument dwFlags) specify loading of the programming library in a way that executes its code.

In an extension of the second embodiment (Procedure 2a), after determining that an attempt to load the programming library from the current working directory will take place, the system prevents the attempt by conditionally or unconditionally doing one or more of the following:
modifying the input arguments of the called function such that loading of the programming library from the current working directory will not succeed or the library's code will not execute (e.g., by changing the path to the programming library or the flags);
setting the current working directory to a location where a malicious person can't create an executable file; or
terminating the execution of the called function and thereby the procedure of loading the programming library.

In a third embodiment (Procedure 3) the system detects calls to function LdrLoadDll. If the path to the programming library (argument ModuleFileName) is relative, the system checks for the existence of files on the file system upon function entry and determines in advance whether the procedure for finding the library will find it in some location in the search path (argument PathToFile—locations are specified in order of searching and separated by semicolons) before trying to find it in the current working directory (denoted as “.”). If a file with such name is not found in the locations in the search path preceding the current working directory, the system concludes that an attempt to load the programming library from the current working directory will take place.

A variation of this third embodiment (Procedure 3.1) is the same as procedure 3, but in addition the system checks whether the flags (argument Flags) specify loading of the programming library in a way that executes its code.

In an extension of the embodiments of both Procedures 3 and 3.1 (Procedure 3a), after determining that an attempt to load the programming library from the current working directory will take place, the system prevents it by conditionally or unconditionally doing one or more of the following:
modifying the input arguments of the called function such that loading of the programming library from the current working directory will not succeed or the library's code will not execute (e.g., by changing the path to the programming library, changing the flags or removing the current working directory—location >>.<<—from the search path);
setting the current working directory to a location where a malicious person can't create an executable file; or
terminating the execution of the called function and thereby the procedure of loading the programming library.

In a fourth embodiment (Procedure 4) the system is programmed to detect calls to function NtQueryAttributesFile. If the path to the file (member ObjectName of argument ObjectAttributes) is relative and the file name indicates an executable file (e.g., the file extension is >>DLL<< or >>EXE<<), it is likely that an attempt to load the programming library from the current working directory or an attempt to launch a computer program from the current working directory will take place.

In a variation of the fourth embodiment, (Procedure 4.1) the system is programmed to detect calls to function NtQueryAttributesFile during the procedure of loading a programming library: upon function entry, the system determines whether a procedure of loading a programming library is underway and whether the file path (member ObjectName of argument ObjectAttributes) is relative. If both conditions are met, it means that an attempt to load the programming library from the current working directory will take place. Determining whether a procedure of loading a programming library is underway is implemented in one of the following ways:
upon detecting calls to some or all functions LoadLibraryA, LoadLibraryW, LoadLibraryExA, LoadLibraryExW or LdrLoadDll the system stores a temporary marker (e.g., in the process's memory, in the registry or on disk) indicating that the procedure of loading a programming library is underway, such that this marker will be accessible from function NtQueryAttributesFile.
upon detecting calls to some or all functions LoadLibraryA, LoadLibraryW, LoadLibraryExA, LoadLibraryExW or LdrLoadDll the system conditionally stores a temporary marker (e.g., in the process's memory, in the registry or on disk) indicating that the procedure of loading a programming library is underway, such that this marker will be accessible from function NtQueryAttributesFile; The marker is conditioned by whether flags (argument dwFlags of function LoadLibraryEx or argument Flags of function LdrLoadDll) specify loading of a programming library in an executable way.
during the execution of function NtQueryAttributesFile, the system inspects the call stack of the current thread and thus determines whether this function was directly or indirectly invoked by any one of the functions LoadLibraryA, LoadLibraryW, LoadLibraryExA, LoadLibraryExW or LdrLoadDll.

In an extension of both of the fourth embodiments of procedures 4 and 4.1 (Procedure 4a), after determining that an attempt to load the programming library from the current working directory will take place, the system prevents the attempt by conditionally or unconditionally doing one or more of the following:
modifying the input arguments of the called function such that it will return an error code to the caller, indicating that the file does not exist or could not be opened;
setting the current working directory to a location where a malicious person can't create an executable file;
terminating the execution of the called function and thereby the procedure of checking for the presence of the programming library in the current working directory; or
returning an error code to the caller, indicating that the file does not exist or could not be opened.

In a fifth embodiment (Procedure 5) the system is programmed to detect calls to function RtlAppendUnicodeStringToString during the procedure of loading a programming library. Upon function entry, the system determines whether a procedure of loading a programming library is underway and whether the target string (the first argument of this function) equals >>./<< (dot and forward slash). If both conditions are met, it means that an attempt to load the programming library from the current working directory will take place. Determining whether a procedure of loading a programming library is underway is implemented in the same way as in procedure 4.1 discussed previously.

In an extension of the fifth embodiment (Procedure 5a), after determining that an attempt to load the programming library from the current working directory will take place, the system prevents the attempt by conditionally or unconditionally doing one or more of the following:
modifying the input arguments of the called function such that the resulting string returned by the function will not represent a path to an existing programming library in the current working directory;
setting the current working directory to a location where a malicious person can't create an executable file;
terminating the execution of the called function and thereby the procedure of checking for the presence of the programming library in the current working directory; or
returning such a string to the caller that does not represent a path to an existing programming library in the current working directory.

In a sixth embodiment (Procedure 6) the system is programmed to detect calls to one or both functions NtCreateSection, ZwCreateSection (NtCreateSection possibly in the operating system kernel). If the provided object name (member ObjectName of argument ObjectAttributes) represents a relative path to a programming library or an absolute path under the current working directory, the system concludes that an attempt to load a programming library from the current working directory will take place.

In an extension of the sixth embodiment (Procedure 6a), after determining that an attempt to load a programming library from the current working directory will take place, the system prevents the attempt by conditionally or unconditionally doing one or more of the following:
modifying the input arguments of the called function such that the object name does not represent a path to an existing programming library in the current working directory;
setting the current working directory to a location where a malicious person can't create an executable file;
terminating the execution of the called function and thereby the procedure of loading a programming library in the current working directory; or
returning an error code to the caller, indicating that loading of the programming library has failed.

The following describes detection and prevention of launching computer programs from the current working directory. Detection and prevention of launching computer programs from the current working directory is implemented with any combination of the following procedures.

In a seventh embodiment of the present invention (Procedure 7), the system is programmed to detect calls to some or all functions CreateProcessA, CreateProcessW, CreateProcessAsUserA, CreateProcessAsUserW, CreateProcessWithLogonW, CreateProcessWithTokenW, CreateProcessInternalA, and CreateProcessInternalW. If the specified path to the computer program (argument lpApplicationName) is relative, the system concludes that an attempt to launch a computer program from the current working directory will take place.

In a variation of the seventh embodiment (Procedure 7.1) the system is programmed to detect calls to one or more of functions CreateProcessA, CreateProcessW, CreateProcessAsUserA, CreateProcessAsUserW, CreateProcessWithLogonW, CreateProcessWithTokenW, CreateProcessInternalA, and CreateProcessInternalW. If the path to the computer program is not specified (argument lpApplicationName is NULL), while the specified command line (argument lpCommandLine) represents a relative path to a computer program, the system is programmed to check for the existence of files on the file system upon function entry and determine whether a file with such name exists in the directory hosting the currently running process's executable. If such file does not exist, the system concludes that an attempt to launch a computer program from the current working directory will take place.

In an extension of the embodiments of procedures 7 and 7.1 (Procedure 7a), after determining that an attempt to launch a computer program from the current working directory will take place, the system prevents the attempt by conditionally or unconditionally doing one or more of the following:
modifying the input arguments of the called function such that the launching of the computer program will fail (e.g., by setting the value of argument lpApplicationName to a string that doesn't represent a path to a computer program in the current working directory);
setting the current working directory to a location where a malicious person can't create an executable file; or
terminating the execution of the called function and thereby the procedure of launching a computer program;

In an eighth embodiment of the present invention (Procedure 8), the system is programmed to detect calls to function WinExec. If the specified command line (argument lpCmdLine) denotes a relative path to a computer program, the system is programmed to check for the existence of files on the file system upon function entry and determine whether a file with such name exists in the directory hosting the currently running process's executable. If such a file does not exist, the system concludes that an attempt to launch a computer program from the current working directory will take place.

In an extension of eighth embodiment (Procedure 8a), after determining that an attempt to launch a computer program from the current working directory will take place, the system prevents the attempt by conditionally or unconditionally doing one or more of the following:
modifying the input arguments of the called function such that the launching of the computer program will fail (e.g., by setting the value of argument lpCmdLine to a string that doesn't begin with a path to a computer program in the current working directory);
setting the current working directory to a location where a malicious person can't create an executable file; or
terminating the execution of the called function and thereby the procedure of launching a computer program;

In a ninth embodiment (Procedure 9), the system is programmed to detect calls to some or all functions ShellExecuteA, ShellExecuteW, ShellExecuteEx, ShellExecuteExA, ShellExecuteExW. If the first two or all of the following conditions are met:
1. specified file (lpFile) is a relative path to an executable computer program,
2. specified directory (lpDirectory) has value NULL and
3. specified operation (lpOperation) has value NULL or >>open<<,
   the system concludes that an attempt to launch a computer program from the current working directory will take place.

In an extension of the ninth embodiment, (Procedure 9a) after determining that an attempt to launch a computer program from the current working directory will take place, the system prevents the attempt by conditionally or unconditionally do one or more of the following:
modifying the input arguments of the called function such that the launching of the computer program will fail (e.g., by setting the value of argument lpFile to a string that doesn't represent a relative or absolute path to a computer program in the current working directory);
setting the current working directory to a location where a malicious person can't create an executable file; or
terminating the execution of the called function and thereby the procedure of launching a computer program;

In a tenth embodiment of the present invention (Procedure 10) the system is programmed to detect calls to one or both functions NtCreateProcess, ZwCreateProcess (NtCreateProcess possibly in the operating system kernel). If the provided object name (member ObjectName of argument ObjectAttributes) represents a relative path to a computer program or an absolute path under the current working directory, the system concludes that an attempt launch a computer program from the current working directory will take place.

In an extension of the tenth embodiment, (Procedure 10a), after determining that an attempt to launch a computer program from the current working directory will take place, the system prevents the attempt by conditionally or unconditionally doing one or more of the following:
modifying the input arguments of the called function such that the launching of the computer program will fail (e.g., by setting the value of member ObjectName of argument ObjectAttributes to a string that doesn't represent a relative or absolute path to a computer program in the current working directory);
setting the current working directory to a location where a malicious person can't create an executable file;
terminating the execution of the called function and thereby the procedure of launching a computer program; or
returning an error code to the caller, indicating that the loading of computer program has failed.

In an eleventh embodiment (Procedure 11), the system is programmed to detect calls to function NtQueryAttributesFile. If the specified path to the file (member ObjectName of argument ObjectAttributes) is relative, and the file name implies a computer program (e.g., the file name has an “EXE” extension), the system concludes that an attempt to launch a computer program from the current working directory will take place.

In a variation of the eleventh embodiment of the present invention (Procedure 11.1), the system is programmed to detect calls to function NtQueryAttributesFile during the procedure of launching a computer program. Upon function entry, the system determines whether a procedure of launching a computer program is underway and whether the specified file path (member ObjectName of argument ObjectAttributes) is relative. If both conditions are met, it means that an attempt to launch a computer program from the current working directory will take place. Determining whether a procedure of launching a computer program is underway is implemented in one of the following ways:
upon detecting calls to some or all functions CreateProcessA, CreateProcessW, CreateProcessAsUserA, CreateProcessAsUserW, CreateProcessWithLogonW, CreateProcessWithTokenW, CreateProcessInternalA, CreateProcessInternalW, or WinExec the system stores a temporary marker (e.g., in the process's memory, in the registry or on disk) indicating that the procedure of launching a computer program is underway, such that this marker will be accessible from function NtQueryAttributesFile.
during the execution of function NtQueryAttributesFile, the system inspects the call stack of the current thread and thus determine whether this function was directly or indirectly invoked by any one of the functions CreateProcessA, CreateProcessW, CreateProcessAsUserA, CreateProcessAsUserW, CreateProcessWithLogonW, CreateProcessWithTokenW, CreateProcessInternalA, CreateProcessInternalW or WinExec.

In an extension of the eleventh embodiments of procedures 11 and 11.1, (Procedure 11a), after determining that an attempt to launch a computer program from the current working directory will take place, the system prevents the attempt by conditionally or unconditionally doing one or more of the following:
modifying the input arguments of the called function such that it will return an error code to the caller, indicating that the computer program does not exist or could not be opened;
setting the current working directory to a location where a malicious person can't create an executable file; or
terminating the execution of the called function and thereby the procedure of checking for the presence of the computer program in the current working directory.

In a twelfth embodiment (Procedure 12), the system is programmed to detect calls to one or more functions that play part in loading or launching executable files and whose arguments contain name and path to the executable file to be loaded or launched: If this path is relative, the system creates a “planted” file with the name of the loaded/launched executable file in the current working directory before continuing the execution of the function code, and then determine whether this file was in fact loaded or launched. Determining whether this file was in fact loaded or launched is implemented in one of the following ways:
monitoring the usage of file system, e.g. with a file system monitor or an API call monitor;
making the “planted” file executable and detecting the execution of its code or the code of other executable files which it launches such that the said code notifies, records or displays some proof of its execution, or notifies the user in some other way.

The following describes other methods of prevention of loading programming libraries and launching computer programs from the current working directory.

Limiting and preventing the loading of programming libraries and launching computer programs from the current working directory is also possible by using an arbitrary combination of the following methods, separately or combined arbitrarily with the procedures described thus far.
In some or all existing processes, once or many times, conditionally or unconditionally, the system triggers a call to function SetDllDirectory with an empty string or a string specifying a file system location where a malicious person can't create an executable file.
The system modifies the behavior of the mechanism of loading executables such that these—conditionally or unconditionally—do not get loaded from the current working directory when the latter is set to a file system location where a malicious person could create an executable file.
By modifying the source code of the operating system's executable files the behavior of the mechanism of loading executables is modified such that these—conditionally or unconditionally—do not get loaded from the current working directory when the latter is set to a file system location where a malicious person could create an executable file. (Only Microsoft's developers can implement such modification as the source code of Microsoft Windows operating system is not publicly accessible.)
The system modifies the behavior of some to all functions LoadLibraryA, LoadLibraryW, LoadLibraryExA, LoadLibraryExW, LdrLoadDll such that eventual environment variables (e.g., >>% SystemPath %<<) in input argument lpFileName automatically get expanded (replaced by the string they represent in the system environment) before they might be used in their “unexpanded” form in the process of searching for a programming library.
By modifying the source code of the operating system's executable files the behavior of some or all functions LoadLibraryA, LoadLibraryW, LoadLibraryExA, LoadLibraryExW, LdrLoadDll is modified such that eventual environment variables (e.g., >>% SystemPath %<<) in input argument lpFileName automatically get expanded (replaced by the string they represent in the system environment) before they might be used in their “unexpanded” form in the process of searching for a programming library. (Only Microsoft's developers can implement such modification as the source code of Microsoft Windows operating system is not publicly accessible.)

The vulnerability addressed by this invention can also be limited by preventing or limiting the setting of the current working directory to file system locations where a malicious person might be able to create an executable file. This can be done using the following methods:
In some or all existing processes, once or many times, conditionally or unconditionally, the system sets the current working directory to a file system location where a malicious person can't create an executable file.
By monitoring some or all functions ShellExecuteA, ShellExecuteW, ShellExecuteEx, ShellExecuteExA, ShellExecuteExW and modifying the argument lpDirectory or by monitoring one or more functions CreateProcessA, CreateProcessW, CreateProcessAsUserA, CreateProcessAsUserW, CreateProcessWithLogonW, CreateProcessWithTokenW, CreateProcessInternalA, CreateProcessInternalW and modifying the argument lpCurrentDirectory the system modifies the behavior of some or all Windows applications such that, conditionally or unconditionally, they don't set the current working directory to file system locations where a malicious person could create an executable file. Using this method the system can change the behavior of Windows Explorer such that when a user double-clicks a file, Windows Explorer will not set the current working directory of the associated (launched) application to the location of said file.
By modifying the source code of the operating system's executable files the behavior of some or all functions ShellExecuteA, ShellExecuteW, ShellExecuteEx, ShellExecuteExA, ShellExecuteExW, CreateProcessA, CreateProcessW, CreateProcessAsUserA, CreateProcessAsUserW, CreateProcessWithLogonW, CreateProcessWithTokenW, CreateProcessInternalA, CreateProcessInternalW is modified such that, conditionally or unconditionally, they don't set the current working directory to file system locations where a malicious person could create an executable file. (Only Microsoft's developers can implement such modification as the source code of Microsoft Windows operating system is not publicly accessible.)
By modifying the source code of operating system's executable files the behavior of Windows Explorer is modified such that when a user double-clicks a file, Windows Explorer will not set the current working directory of the associated (launched) application to the location of said file. (Only Microsoft's developers can implement such modification as the source code of Microsoft Windows operating system is not publicly accessible.)

The following describes an example implementation for detecting “binary planting” vulnerabilities for programming libraries.

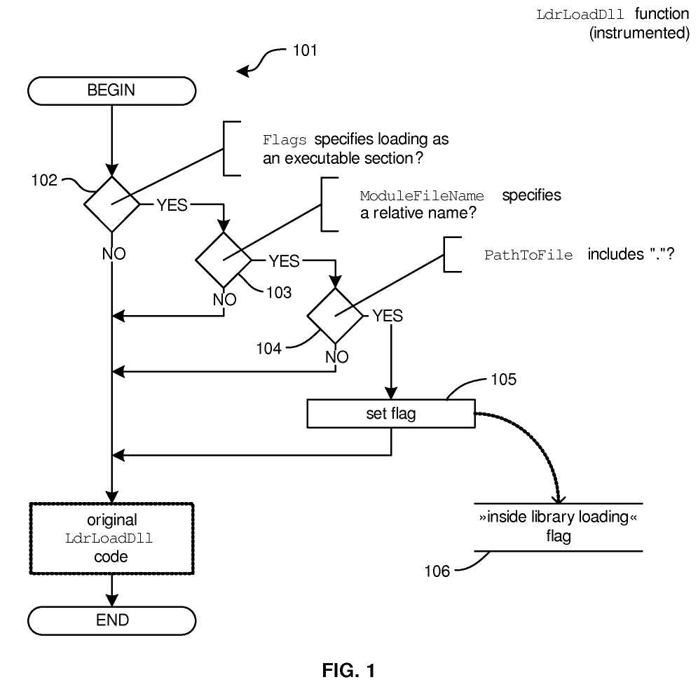

System call hooking is used to monitor calls to function LdrLoadDll. As illustrated on FIG. 1, when a running process explicitly or implicitly requests loading of a programming library, function LdrLoadDll is called (101). This function returns a result of type NTSTATUS and accepts the following arguments:
1. a string of file paths where the programming library is to be searched for;
2. flags, which specify the manner in which the programming library is to be loaded (flags match the flag values for function LoadLibraryEx);
3. programming library's name (name can be a relative or absolute path); and
4. pointer to a memory location for storing a file handle.

The following is relevant upon entering function LdrLoadDll:
Programming libraries can be loaded into memory in two ways: as an executable section or as a data section. Malicious code can only be executed in case the programming library is loaded as an executable section, making loading of programming libraries as data significantly less dangerous.
If function LdrLoadDll gets (in an input argument) an absolute path to a programming library, the search will be limited to this path, rendering the planting of a malicious library into the current working directory impossible.
The string of paths, provided to function LdrLoadDll (individual paths are separated by semicolons) usually includes the current working directory (denoted with a dot in the string of paths).

Based on the above, further monitoring of the process of loading a programming library is meaningful only if the following conditions are met:
1. according to the flags (argument Flags) the programming library is being loaded as an executable section (102);
2. the name of the programming library (argument ModuleFileName) is relative (103); and
3. the supplied search path (argument PathToFile) includes the current working directory (>>.<<) (104).

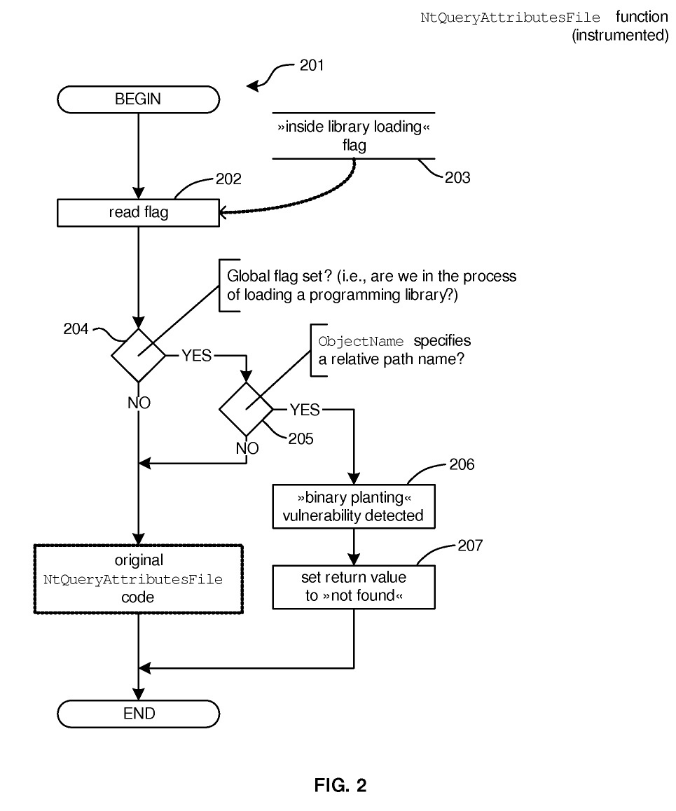

If all three conditions are met, the system stores (105) a flag into a global variable (106) denoting that the process of loading a programming library is underway, then system call hooking is used to monitor calls to function NtQueryAttributesFile (as illustrated on FIG. 2), which occur as a result of the execution of function LdrLoadDll (the system is programmed to check (202) in function NtQueryAttributesFile whether the aforementioned global variable (203—same as 106 on FIG. 1) indicates being in the process of loading a programming library). Calls to function NtQueryAttributesFile (201) are usually executed in the order specified by the search path, provided to function LdrLoadDll in argument PathToFile.

Function NtQueryAttributesFile returns a result of type NTSTATUS and takes two arguments: pointer to a structure of type OBJECT_ATTRIBUTES and pointer to a structure of type FILE_BASIC_INFORMATION, which gets populated with output data. Only the first argument is relevant to us, as it provides the path to the queried file. Structure OBJECT_ATTRIBUTES has 6 members, but only member ObjectName of type PUNICODE_STRING (pointer to structure of type UNICODE_STRING) is relevant to us. Upon every call to function NtQueryAttributesFile the system uses the value of this member to determine which file is being queried and whether the path to it is relative (i.e., it doesn't include a root directory) or absolute (i.e., it includes a root directory). Therefore, if in the process of loading a programming library (204), function NtQueryAttributesFile receives an input argument with a structure where a file path is relative (205), it is highly likely that an attempt to load a programming library from the current working directory is underway—making the process vulnerable to “binary planting” (206). At that point the system can also prevent loading of the programming library, as the actual loading of the programming library depends on the result returned by function NtQueryAttributesFile. If this return value is changed from 0x00000000—STATUS_SUCCESS (denoting that the file exists) into 0xC0000034—STATUS_OBJECT_NAME_NOT_FOUND (denoting that the file doesn't exist), the actual loading of the programming library will not take place (207).

The following describes an example implementation for detecting “binary planting” vulnerabilities for computer programs.

When a running process needs to launch another process, it can do so by using one of the following functions: CreateProcessA, CreateProcessW, CreateProcessAsUserA, CreateProcessAsUserW, CreateProcessWithLogonW, CreateProcessWithTokenW, CreateProcessInternalA, CreateProcessInternalW or WinExec. Each of these functions returns a value of type BOOL and accepts multiple arguments, but the only argument relevant to us is the path to the executable computer program, which can be absolute or relative. In case the path is relative, it is highly likely that the process is vulnerable to planting executable computer programs in the current working directory. In this case, all abovementioned functions (or their sub-functions) use function NtQueryAttributesFile to check for the existence of the executable file in the home directory (the directory hosting the computer program of the calling process). If the executable file is not found there, its existence is again checked in the current working directory (using function NtQueryAttributesFile)—if found there, the functions load this file into memory and execute it.

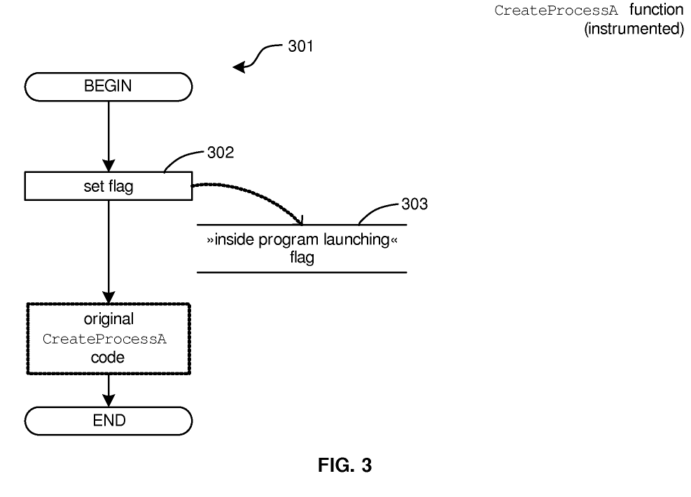

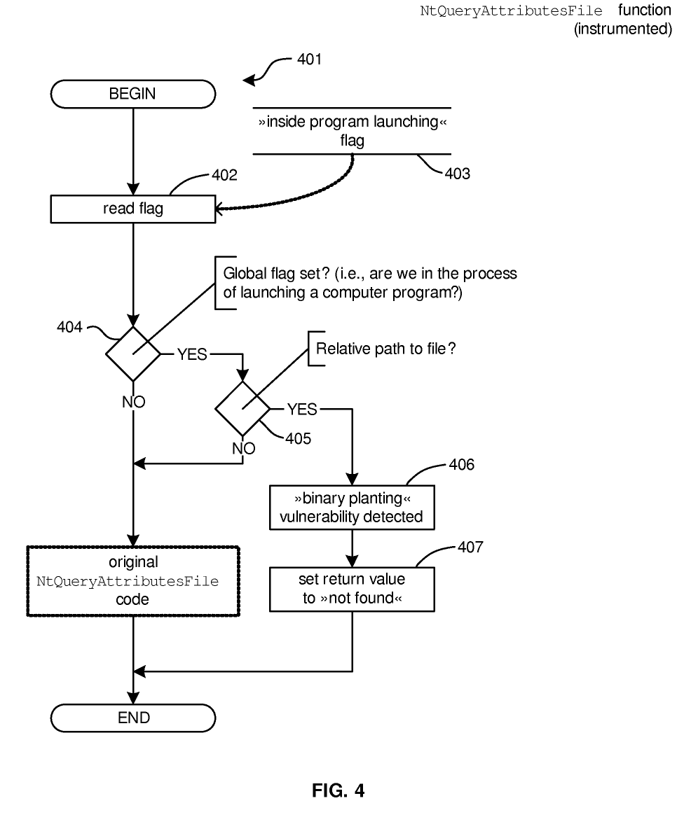

As illustrated on FIG. 3 (showing a case of function CreateProcessA), the system implements vulnerability detection using “call hooking” to all abovementioned functions (301); early in their execution, storing (302) a flag into a global variable (303) denoting that the process of launching a computer program is underway, then, as illustrated on FIG. 4 (similar to FIG. 2), the system uses system call hooking to monitor calls to function NtQueryAttributesFile (401), which occur as a result of the execution of these functions (the system is programmed to check (402) in function NtQueryAttributesFile whether the aforementioned global variable (403—same as 303 on FIG. 3) indicates being in the process of launching a computer program).

If in the process of launching a computer program (404), function NtQueryAttributesFile receives an input argument with a relative path to file (405), it is highly likely that an attempt to launch a computer program from the current working directory is underway (406). At that point the system can prevent launching of the computer program in a similar way as was done in the previous example implementation—by setting the result value to 0xC0000034—STATUS_OBJECT_NAME_NOT_FOUND (407).

While the preferred embodiment and various alternative embodiments of the invention have been disclosed and described in detail herein, it may be apparent to those skilled in the art that various changes in form and detail may be made therein without departing from the spirit and scope thereof.

We claim:

1. A computer-performed method for detection and/or prevention of loading executable files from the current working directory, based on relative file paths and the expected order of searching for such files, the method comprising:
monitoring calls of one or more functions of an operating system, in user space or kernel space;
determining, in a processor, based on one or more of (1) a relative path to an executable file in their input arguments, (2) the expected order of searching for such file, and (3) such file's absence in priority locations in the search path, that an attempt to load or launch an executable file from the current working directory will take place;
executing one or more of the following actions:
(a) blocking the attempt to load or launch an executable file from the current working directory,
(b) indicating, to one or more of: (i) a database, (ii) a file, (iii) computer memory, (iv) a computer process, (v) another computer, (vi) a computer peripheral device, and (vii) a user of the computer, that an attempt to load or launch an executable file from the current working directory has taken place.

2. A method in accordance with claim 1, wherein the step of monitoring further comprises monitoring calls to one or more of functions LoadLibraryA, LoadLibraryW, LoadLibraryExA, LoadLibraryExW, LdrLoadDll, NtCreateSection, ZwCreateSection, CreateProcessA, CreateProcessW, CreateProcessAsUserA, CreateProcessAsUserW, CreateProcessWithLogonW, CreateProcessWithTokenW, CreateProcessInternalA, CreateProcessInternalW, WinExec, ShellExecuteA, ShellExecuteW, ShellExecuteEx, ShellExecuteExA, ShellExecuteExW, NtCreateProcess or ZwCreateProcess, and
wherein, the step of determining further comprises determining, in a processor, based on a relative path to a file in these functions' input arguments, that an attempt to load an executable file from the current working directory will take place.

3. A method in accordance with claim 1, wherein the step of monitoring further comprises:
monitoring calls to function NtQueryAttributesFile and determining, in a processor, based on a relative path to a file in this function's input argument, that an attempt to load or launch an executable file from the current working directory will take place.

4. A method in accordance with claim 1, wherein the step of monitoring further comprises:
monitoring calls to function NtQueryAttributesFile and determining, in a processor, based on a relative path to a file in this function's input argument and a fact that such function call occurs during the process of loading a programming library or launching a computer program, that an attempt to load or launch an executable file from the current working directory will take place.

5. A method in accordance with claim 1, wherein the step of monitoring further comprises:
monitoring calls to function RtlAppendUnicodeStringToString and determining, in a processor, based on the target string (the first argument to function RtlAppendUnicodeStringToString) being equal to >>./<< and a fact that such function call occurs during the process of loading a programming library, that an attempt to load or launch an executable file from the current working directory will take place.

6. A method in accordance with claim 1, wherein the step of blocking further comprises:
preventing an attempt to load or launch an executable file from the current working directory by any of the following actions or a combination thereof:
modification of the monitored function's input arguments,
changing the current working directory,
calling the SetDllDirectory function with either an empty string or a string denoting a file system location where a malicious person can't create an executable file,
termination of the monitored function's execution, and
returning such error code to the calling function that it will not try to load or launch the executable file.

7. A method in accordance with claim 1, wherein the step of determining further comprises:
determining, in a processor, that an attempt to load or launch an executable file from the current working directory is about to take place, and
automatically creating such executable file on the file system, then determining, based on monitoring the usage of this file or based on the execution of this file's code, whether this file would in fact be loaded or executed from the current working directory.

8. A method for use in a processor modifying the behavior of an operating system for one or more processes running on the processor, comprising:
modifying, using one or more of:
instrumentation,
binary code modification, and
source code modification,
behavior of mechanisms for loading and launching executable files such that, one or more of the following functions are preformed by the processor:
executable files are prevented from being at least one of loaded and executed from the current working directory,
the current working directory in the processor is prevented from being set to predetermined file system locations, and
the current working directory in the processor is prevented from being set at all.

9. A method in accordance with claim 8, wherein the step of modifying the behavior of mechanisms for loading executable files, such that executable files are prevented from being at least one of loaded and executed from the current working directory further comprises the step of:
detecting when the current working directory is set to predetermined file system locations, the predetermined file system locations determined by one or more of:
(a) a specified list of predetermined file system locations,
(b) predetermined patterns of file system locations,
(c) a programming logic programmed to determine predetermined file system locations; and
(d) any combination (a)-(c) above.

10. A method in accordance with claim 8, further comprising:
modifying behavior of some or all functions LoadLibraryA, LoadLibraryW, LoadLibraryExA, LoadLibraryExW, LdrLoadDll, such that eventual environment variables (e.g., >>% SystemPath %<<) in their input argument lpFileName are automatically “expanded” in the processor (replaced by the string they represent in the system environment) before being used in their “unexpanded” form in the process of searching for a programming library in the processor.

11. A method in accordance with claim 8, further comprising:
modifying the behavior of some or all functions ShellExecuteA, ShellExecuteW, ShellExecuteEx, ShellExecuteExA, ShellExecuteExW, CreateProcessA, CreateProcessW, CreateProcessAsUserA, CreateProcessAsUserW, CreateProcessWithLogonW, CreateProcessWithTokenW, CreateProcessInternalA, CreateProcessInternalW, such that they, do not set the current working directory to predetermined file system locations, the predetermined file system locations determined by one or more of:
(a) a specified list of predetermined file system locations,
(b) predetermined patterns of file system locations,
(c) a programming logic programmed to determine predetermined file system locations; and
(d) any combination (a)-(c) above.

12. A method in accordance with claim 8, further comprising:
monitoring calls to some or all functions ShellExecuteA, ShellExecuteW, ShellExecuteEx, ShellExecuteExA, ShellExecuteExW and modifying, in the processor, their input argument lpDirectory such that the current working directory is prevented from being set to predetermined file system locations, the predetermined file system locations determined by one or more of:
(a) a specified list of predetermined file system locations,
(b) predetermined patterns of file system locations,
(c) a programming logic programmed to determine predetermined file system locations; and
(d) any combination (a)-(c) above.

13. A method in accordance with claim 8, comprising:
monitoring calls to some or all functions CreateProcessA, CreateProcessW, CreateProcessAsUserA, CreateProcessAsUserW, CreateProcessWithLogonW, CreateProcessWithTokenW, CreateProcessInternalA, CreateProcessInternalW, and modifying their input argument lpCurrentDirectory such that the current working directory is prevented from being set to predetermined file system locations, the predetermined file system locations determined by one or more of:
(a) a specified list of predetermined file system locations,
(b) predetermined patterns of file system locations,
(c) a programming logic programmed to determine predetermined file system locations; and
(d) any combination (a)-(c) above.

14. A method in accordance with claim 8, further comprising:
modifying the behavior of a file management application running on the processor such that, upon a user double-clicking on a file, the processor does not set the current working directory of the launched (associated) application to the location of the file.

15. A computer-performed method for prevention of loading malicious executable files from the current working directory, the method comprising:
executing, in one or more existing processes on the computer, at least one time, one or more actions that perform one or more of the steps of:
modifying behavior of mechanisms for loading and launching executable files; and
changing the current working directory to a location where a malicious person could not create an executable file.

16. A method in accordance with claim 15, further comprising:
setting, in one or more existing processes, at least one time, the current working directory to a file system location, the file system location determined by one or more of:
(a) a specified list of predetermined file system locations,
(b) predetermined patterns of file system locations,
(c) a programming logic programmed to determine predetermined file system locations; and
(d) any combination (a)-(c) above.

17. A method in accordance with claim 15, further comprising:
triggering, in one or more existing processes, at least one time, a call to function SetDllDirectory with an empty string or a string denoting a file system location, the file system location determined by one or more of:
(a) a specified list of predetermined file system locations,
(b) predetermined patterns of file system locations,
(c) a programming logic programmed to determine predetermined file system locations; and
(d) any combination (a)-(c) above.
